(19) United States
(12) Patent Application Publication
(10) Pub. No.: US 2024/0159943 A1
(43) Pub. Date: May 16, 2024

(54) METHOD FOR MANUFACTURING AN OPTICAL MODULE AND OPTICAL MODULE

(71) Applicant: Optotune Switzerland AG, Dietikon (CH)

(72) Inventor: Manuel Aschwanden, Dietikon (CH)

(73) Assignee: Optotune Switzerland AG, Dietikon (CH)

(21) Appl. No.: 18/505,700

(22) Filed: Nov. 9, 2023

(30) Foreign Application Priority Data
Nov. 11, 2022 (DE) 10 2022 129 959.7

(51) Int. Cl. G02B 3/14; G02B 1/11

(52) U.S. Cl. CPC G02B 3/14; G02B 1/11

(57) ABSTRACT

An optical module (1) comprising a tunable optical component (1) at least with two optical surfaces (3, 4) and a deformable internal space between the two optical surfaces (3, 4), wherein the internal space is filled with a transparent liquid (5), and wherein an optical property of the tunable optical component (2) is adjustable by altering a shape of the internal space, and a first optical element (8) that is attached to one of the optical surfaces (3, 4) facing away from the internal space, and wherein a second optical element (9) is kitted to the first optical element (8) via a van-der-Waals-bond and/or a chemical bond, in particular an adhesive chemical bond, and/or a plasma activated bond.

### CROSS-REFERENCE TO RELATED APPLICATIONS

This application claims the right of priority of German Patent Application No. DE 10 2022 129 959.7, filed Nov. 11, 2022, the contents of which are incorporated by reference herein in their entirety.

### FIELD

The invention relates to a method according to claim 1 and an optical module according to claim 7.

### BACKGROUND OF THE INVENTION

Optical modules are used in various applications to direct or focus light beams. In imaging optical systems with a camera, such an optical module can be designed as a collecting optical system that generates an optical image of an object that can be captured by means of an image sensor. One possible application of such optical modules is related to mobile phones. It is desirable to be able to change the optical properties of such an optical module as required in order to be able to react to variable operating conditions.

In order to be able to guarantee the economic usability of optical modules in mobile phones, it must furthermore be ensured in the production of the optical modules that they are manufactured with low scrap rates. Therefore, achieving a high-yield optical module is critical to push the boundaries of mobile phone cameras. At the same time, it is desired to keep production costs low. Since image sensors have increased in size while pixels are becoming smaller the requirements for optical modules have developed to a point where it has become challenging to achieve the required specifications.

It is an objective of the invention to propose a method for the manufacture of an optical module as well as an optical module that allow the existing requirements to be met.

The objective is solved by a method according to claim 1 and an optical module according to claim 7. Preferred embodiments are subject-matters of dependent claims.

### SUMMARY OF THE INVENTION

According to the invention, the method for manufacturing an optical module, comprises the following steps
A) Providing a tunable optical component and a first optical element. The tunable optical component comprises two optical surfaces and a deformable internal space between the two optical surfaces. The internal space is filled with a transparent liquid. An optical property of the tunable optical component is adjustable by altering a shape of the internal space. The first optical element is attached to one of the optical surfaces facing away from the internal space;
B) Measurement of at least one optical property of the tunable optical component and/or the first optical element;
C) Providing a second optical element;
D) Joining the second optical element with the first optical element to form the optical module.

### BRIEF DESCRIPTION OF THE DRAWINGS

In the following, examples of the present invention and its preferred embodiments are described with reference to the accompanying drawings.

FIG. 1 shows an optical module according to the invention in a schematic side view;

FIGS. 2A-2B show the optical module optical module changing an optical property in views 2A) and 2B);

FIG. 3 shows another embodiment of the optical module.

### DETAILED DESCRIPTION OF THE INVENTION

It is an advantage of the invention, that a tunable optical component is used to set the optical properties of the optical module in a simple manner. Furthermore, it is an advantage that said tunable optical component, which is quality critical for the optical module, can be controlled with respect to its quality before it is assembled with further components of the optical module. Particularly, a higher production yield can be achieved. At the same time, the overall height of the optical assembly is reduced.

According to the invention, the tunable optical component has at least one optical property, which can be adjusted by altering the shape of the internal space. The invention is not limited to a specific design of the tunable optical component or which optical property is adjustable. Preferably, the first optical surface and the second optical surface are each at least partly transparent in an area that is arrangeable in an optical path of the tunable optical component. The invention is not limited to how the optical path of the optical module extends. Rather, it is within the scope of the invention that the optical path is linear or angular. At least in the context of the invention described here, in the case of a linear optical path, the term optical axis can be used synonymously.

Preferably, the first optical surface and the second optical surface are relatively displaceable to each other. A deformation of the internal space can therefore basically take place by completely or partially displacing the first optical surface and the second surface relative to each other. Preferably, the internal space in relation to the optical path of the optical tunable component is laterally limited by a circumferential element, such as a bellow, which may be flexible. By deforming the internal space, an optical property of the tunable optical component is adjusted such that the quality of a captured image may be improved effectively, if the optical module is part of an optical imaging system.

Preferably, in at least one state of the tunable optical component, the first optical surface and/or the second optical surface are flat and spaced parallel to each other. It is also within the scope of the invention that, in at least one state of the imaging optical system, the first and/or the second optical surface each have a curved shape. The invention is not limited to a specific transparent liquid, which, in a simple embodiment, may be an optical oil or another suitable liquid. By deforming the internal space, it is possible to influence a light beam entering the optical imaging system along the optical path.

It is also within the scope of the invention that the first optical element is at least partially transparent and arranged in an optical path that impinges both the first and the second optical surface. It is an advantage that a transparent window, in particular a flat glass window, can be used as the first optical element. The flat glass allows for a reduced requirement on the centering of the glass and therefore for a higher production yield.

The second optical element can be used to refocus and/or redirect a beam of light that passes through the tunable optical component and the first optical element along the optical path. The second optical element can be an optical folding element such as a prism or a mirror. Alternatively, the second optical element may also be a solid lens. Regardless of the embodiment of the second optical element, it is an advantage that no air gap is formed between the first and the second optical element. This makes it possible to achieve a compact design of the optical module.

It is essential to the invention that the optical property of the tunable optical component is measured before the first and second optical elements are joined in step D). This makes it possible to first ensure that quality-critical components of the optical module are of the required quality before they are assembled with other components to form the optical module. If it is determined during the measurement that the optical properties of the tunable optical component are not as desired, the tunable optical component can be excluded from the assembly process. This can prevent costly processing or manufacturing steps from being carried out on or with defective components.

According to a preferred embodiment of the invention, in step D) the second optical element is at least partially brought in direct contact with the first optical element. In particular, the joining of the second optical element with the first optical element comprises a formation of a van-der-Waals-bond and/or a chemical bond, in particular an adhesive chemical bond, and/or a plasma activated bond.

Investigations have shown that the aforementioned joining methods can be used to create a reliable connection between the first and second optical elements. At the same time, impairment of the optical properties of the first and second optical elements can be avoided, since the joining methods mentioned are particularly non-damaging or harmful with regard to the first and second optical elements.

According to a preferred embodiment, in step D) the second optical element and the first optical element are free of an antireflection coating, particularly in a contact zone.

It is an advantage of the above-described further development that additional process steps, in which the first and the second optical element are coated are avoided in the manufacture of the optical module. This saves material costs, in particular because no costly anti-reflective coatings need to be used, compared to arrangements with an air gap. In addition, the time required to assemble the optical module can be reduced.

According to another preferred embodiment, in step B) a quality information of the tunable optical component and/or the first optical element is determined as a function of the measured optical property. In particular, step B) comprises an optical measurement of the optical property of the tunable optical component and/or the first optical element.

An optical measurement of the tunable optical component and/or the first optical element allows a quality control that is both reliable and easy to automate. This further improves the production of the optical module.

As mentioned above, the invention also relates to an optical module according to claim 7.

According to the invention, the optical module comprises a tunable optical component at least with two optical surfaces and a deformable internal space between the two optical surfaces. The internal space is filled with a transparent liquid, and wherein an optical property of the tunable optical component is adjustable by altering a shape of the internal space. The optical module also comprises a first optical element that is attached to one of the optical surfaces facing away from the internal space. A second optical element is kitted to the first optical element via a van-der-Waals-bond and/or a chemical bond, in particular an adhesive chemical bond, and/or a plasma activated bond.

Preferably, the optical module is manufacturable by a method according to the invention or a preferred embodiment of the method. In this respect, with regard to the advantages that can be achieved with the optical module according to the invention, the explanations on the method according to the invention or an advantageous further development thereof apply accordingly.

According to a preferred embodiment, a contact zone between the first optical element and the second optical element is free of an antireflection coating. This reduces the manufacturing costs for the optical module.

According to another preferred embodiment, the tunable optical component is a tunable lens, wherein in particular the optical surfaces of the tunable optical component each are deformable membranes. Moreover, the first optical element is a transparent window that is attached to one of the deformable membranes.

By means of the above described embodiment, a deformation of at least one of the membranes may serve to deform the internal space and to change at least one optical property of the tunable optical component. An relative adjustment of the first optical element with respect to the tunable optical component serves to change the pressure of the liquid in the internal space and thereby cause a curvature of one of the membranes. It is within the scope of the preferred embodiment that the tunable optical component is moveable with respect to the first optical component.

According to another preferred embodiment, the tunable optical component is a tunable prism, wherein in particular the optical surfaces of the tunable optical component each are rigid optical windows. By adjusting the rigid optical windows relative to each other, an optical property of the tunable optical component can be set.

According to a preferred embodiment, the second optical element is a folding element, in particular a rigid prism or a mirror. The folding element can be considered as an optical component that deflects and/or diverges the path of a light beam. Preferably, the first folding element defines a first light entry axis and a first light exit axis that enclose a folding angle of at least 30°, preferably at least 45°, highly preferred 90°.

According to another preferred embodiment, the second optical component is a ridig lens. Such a rigid lens preferably has an optical axis, which in at least one state is substantially coaxial with the optical axis of the tunable optical component. The rigid lens may be part of a lens barrel comprising a plurality of rigid lenses.

In a preferred embodiment, the tunable optical component and the first optical element are moveably mounted with respect to each other. At least one actuator is designed to cause a relative displacement and/or a relative rotation between the tunable optical component and the first optical element in order to change at least one optical property of the tunable optical component.

In a simple embodiment, the actuator is electromechanical and comprises at least one electric coil and at least one magnet. In particular, the magnet can be mechanically coupled to the tunable optical component. Preferably, the magnet is arranged in such a way that when a current flow is generated in the coil, a force is exerted on the magnet and this force is transmitted to the tunable optical component. This can generate a relative displacement between the tunable optical component and the first optical element. In particular, the tunable optical component can be moved towards or from the first optical element in such a way that the internal space is deformed.

According to a preferred embodiment, the tunable optical component and the first optical element are displaceable along an optical axis of the optical module. The actuator is designed to cause a linear displacement between the tunable optical component and the first optical element, in particular to change a focal power of the tunable optical component.

An advantage of the advantageous further development described above is that it is possible to map a focusing function by means of the optical module by changing the focal power. This is particularly advantageous when the optical module is used as a part of an imaging optical system.

According to another preferred embodiment, the tunable optical component and the first optical element are displaceable about at least one tilt axis that runs perpendicular to the optical axis of the optical module. The actuator is designed to cause a rotation between the tunable optical component and the second optical element about the tilt axis, in particular to cause an optical image stabilization with the optical module.

An advantage of the further development described above is that the optical module can be used in mobile devices such as mobile phones. In order to improve the image quality, it is possible to compensate for the negative influence of an unsteady guidance of the mobile phone by performing an optical image stabilization.

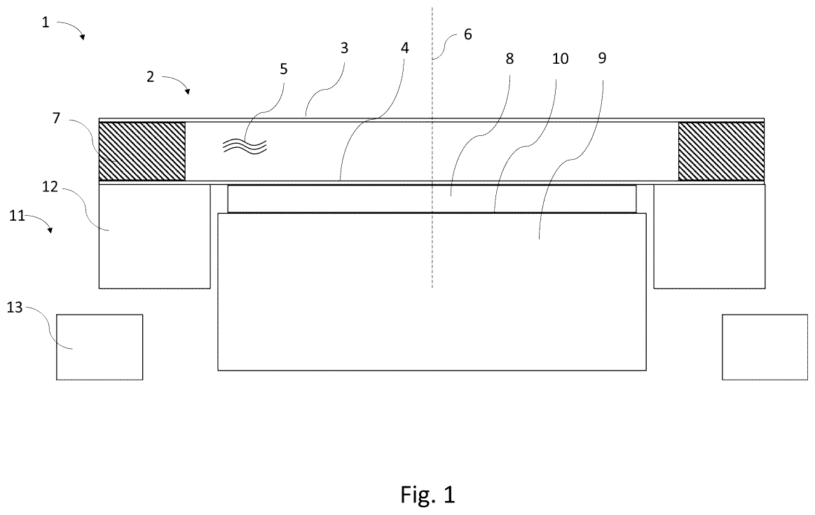

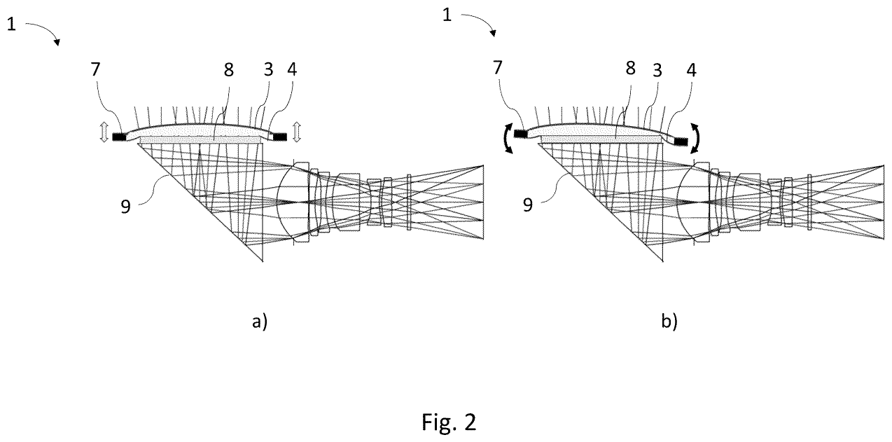

For a better understanding, the reference numerals as used in FIGS. 1 and 2 are listed below.
1 Optical module
2 Tunable optical component
3 First optical surface
4 Second optical surface
5 Optical oil
6 Optical path
7 Bellow
8 First optical element
9 Second optical element
10 Contact zone
11 Actuator
12 Magnet
13 Coil
14 Image sensor

FIG. 1 shows an optical module 1, which can be used as a component of an optical imaging system of a mobile phone in a manner not shown in more detail here. In an alternative embodiment, the optical module 1 can also be used as a component of another optical system.

Regardless of the specific form of application, the optical module 1 comprises at least one optical property that be changed in a simple manner. In particular, the optical module 1 shown can be used to change its focal power as required and thus achieve an autofocus function. It is also possible to perform optical image stabilisation and thus compensate for undesired movements of the optical system in which the optical module 1 is used. This can significantly improve the image quality. The optical module 1 is also advantageous because its design allows the quality of optical systems, in which the optical module 1 is applied, to be improved.

The optical module 1 shown in FIG. 1 comprises a tunable optical component 2 with a first optical surface 3 and a second optical surface 4. An internal space is formed between the two optical surfaces 3 and 4, which is filled with an optical oil 5. The optical surfaces 3 and 4 are each designed as deformable membranes, each of which has a transparent area through which an optical path 6 of the optical module 1 extends. In relation to the optical path 6, the internal space is limited in the lateral direction by a ring-like element, which in this case is designed as a deformable bellow.

By adjusting the two optical surfaces 3 and 4 relative to each other or by deforming at least one of the optical surfaces 3 or 4, it is possible to change at least one optical property of the optical module 1 and thereby, as mentioned above, to change a focal power or to achieve optical image stabilisation.

On a side facing away from the internal space, the second optical surface 4 is connected to a first optical element 8. The first optical element is designed as a transparent window, which is also arranged along the optical path 6.

As will be explained in detail below, the first optical element 8 is mounted in a resting position relative to the tunable optical component 2. In other words, the tunable optical component 1 can be moved relative to the first optical element 8. By applying an adjusting force or torque to the tunable optical component 2, it is possible to move it towards or away from the first optical element 8 and thereby cause a deformation of the internal space.

It is essential to the optical module 1 shown in FIG. 1 that a second optical element 9 is connected to the first optical element 1. The second optical element 9 is an optical folding element in the form of a rigid prism, as can be seen more clearly in FIG. 2.

The first optical element 8 and the second optical element 9 have a common contact zone 10. In the contact zone 10, the first optical element 8 and the second optical element 9 are connected to each other by means of an adhesive bond. In an alternative embodiment, the first optical element 8 and the second optical element 9 can also be at least partially connected to each other by means of a van der Waals connection or a plasma-activated connection.

An important advantage of the connection between the first optical element 8 and the second optical element 9 is that the tunable optical component 2 and the first optical element 8 can be assembled first and tested for their quality. Afterwards, the joining process takes place, in which the first optical element 8 and the second optical element 9 are joined together in the common contact zone 10.

By performing a quality control, which may include an optical measurement of the tunable optical component, prior to the joining step, a defective tunable optical component 2 can be excluded from the further assembly of the optical module. This means that value-adding production steps on defective components can be avoided, making production more efficient overall.

Furthermore, in the embodiment shown here, the contact zone 10 is free of an anti-reflection coating. This means that a corresponding coating process can be avoided, which saves both time and material costs.

In addition, the connection between the first optical element 8 and the second optical element 9 allows an air gap to be avoided, which reduces the overall height of the optical module 1.

For a relative adjustment of the tunable optical component 2 with respect to the first optical element 8, the optical module 1 comprises an actuator 11, which in this case has a plurality of magnets 12 and a plurality of coils 13. For a better overview, only one of the magnets and only one of the coils is marked with reference signs.

The magnets 12 are mechanically coupled to the tunable optical component 2 so that a movement of the magnets 12 can be transmitted to the tunable optical component 2.

The coils 13 are mounted at least in pairs with respect to the magnets 12 in such a way that, when an electric current is flowing, they can exert a magnetic field force on at least one of the magnets 12 in order to move it in a desired manner.

In particular, by moving the magnets 12, it is possible to cause the tunable optical component 2 to move parallel to the optical path 6 shown in FIG. 1. This allows the focal power of the tunable optical component 2 to be changed. In addition or alternatively, the tunable optical component 2 can be tilted about an axis that is perpendicular to the optical path 6. This allows optical image stabilisation to be performed.

The settings of the tunable optical component 2 described above can be seen in FIG. 2. FIG. 2 shows the optical module 1 according to FIG. 1 in views a) and b). View a) shows the optical module 1 during the change of a focal power of the tunable optical component 2. View b) shows the optical module 1 during an optical image stabilisation.

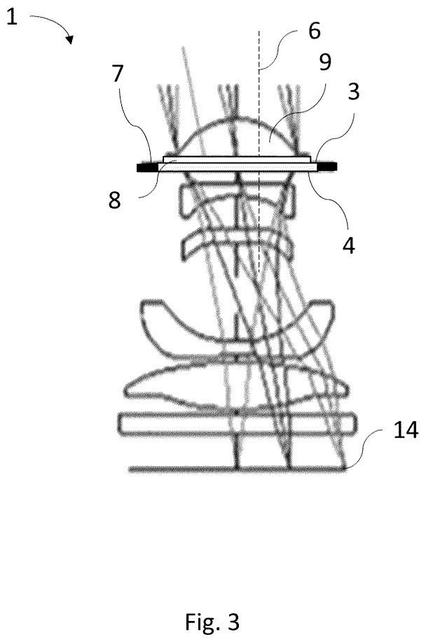

FIG. 3 shows another embodiment of optical module 1 that comprises a tunable optical component 2 with a first optical surface 3 and a second optical surface 4. An internal space is formed between the two optical surfaces 3 and 4, which is filled with an optical oil 5. The optical surfaces 3 and 4 are each designed as deformable membranes, each of which has a transparent area through which an optical path 6 of the optical module 1 extends. In relation to the optical path 6, the internal space is limited in the lateral direction by a ring-like element, which in this case is designed as a deformable bellow 7.

By adjusting the two optical surfaces 3 and 4 relative to each other or by deforming at least one of the optical surfaces 3 or 4, it is possible to change at least one optical property of the optical module 1 and thereby, to change a focal power or to achieve optical image stabilisation.

According to the optical module 1 shown in FIG. 3, the second optical element 9 is a rigid lens that is convex and arranged on a side of the tunable optical component 2 that faces away from an image sensor 14 of the optical module 1.

By means of the optical module 1 shown in FIG. 3, it is possible to change the focal power of the optical module 1 by linearly displacing the tunable optical component 2 relative to the first optical element 8. Image stabilization is possible by tilting the tunable optical component 2 relative to the first optical element 8. In all other respects, the explanations regarding FIGS. 1 and 2 apply accordingly.

1. A method for manufacturing an optical module (1), comprising the following steps
A) providing a tunable optical component (2) and a first optical element (8), wherein the tunable optical component (2) comprises two optical surfaces (3, 4) and a deformable internal space between the two optical surfaces (3, 4), wherein the internal space is filled with a transparent liquid (5), and wherein an optical property of the tunable optical component (2) is adjustable by altering a shape of the internal space, and wherein the first optical element (8) is attached to one of the optical surfaces (3, 4) facing away from the internal space;
B) measurement of at least one optical property of the tunable optical component (2) and/or the first optical element (8);
C) providing a second optical element (9);
D) joining the second optical element (9) with the first optical element (8) to form the optical module (1).

2. The method according to claim 1, wherein
in step D) the second optical element (9) is at least partially brought in direct contact with the first optical element (8).

3. The method according to claim 1, wherein
in step D) the joining of the second optical element (9) with the first optical element (8) comprises a formation of a van-der-Waals-bond and/or a chemical bond, in particular an adhesive chemical bond, and/or a plasma activated bond.

4. The method according to claim 1, wherein
in step D) the second optical element (9) and the first optical element (8) are free of an antireflection coating, in particular in a contact zone (10).

5. The method according to claim 1, wherein
in step B) a quality information of the tunable optical component (2) and/or of the first optical element (8) is determined as a function of the measured optical property.

6. The method according to claim 1, wherein
step B) comprises an optical measurement of the optical property of the tunable optical component (2) and/or of the first optical element (8).

7. Optical module (1), which in particular is manufacturable by a method according to claim 1, comprising
a tunable optical component (1) at least with two optical surfaces (3, 4) and
a deformable internal space between the two optical surfaces (3, 4),
wherein the internal space is filled with a transparent liquid (5), and wherein
an optical property of the tunable optical component (2) is adjustable by altering a shape of the internal space, and
a first optical element (8) that is attached to one of the optical surfaces (3, 4) facing away from the internal space, and wherein
a second optical element (9) is kitted to the first optical element (8) via a van-der-Waals-bond and/or a chemical bond, in particular an adhesive chemical bond, and/or a plasma activated bond.

8. Optical module (1) according to claim 8, wherein
a contact zone (10) between the first optical element (8) and the second optical element (9) is free of an antireflection coating.

9. Optical module (1) according to claim 7, wherein
the tunable optical component (2) is a tunable lens, wherein in particular the optical surfaces (3, 4) of the tunable optical component (2) each are deformable membranes
and wherein the first optical element (8) is a transparent window that is attached to one of the deformable membranes.

10. Optical module (1) according to claim 7, wherein
the tunable optical component (2) is a tunable prism, wherein in particular the optical surfaces (3, 4) of the tunable optical component (2) each are rigid optical windows.

11. Optical module (1) according to claim 8, wherein
the second optical element (9) is a folding element, in particular a rigid prism or a mirror.

12. Optical module (1) according to claim 8, wherein
the second optical element (9) is a ridig lens.

13. Optical module (1) according to claim 8, wherein
the tunable optical component (2) and the first optical element (8) are at least partially moveably mounted with respect to each other, and wherein at least one actuator (11) is designed to cause a relative displacement and/or a relative rotation between the tunable optical component (2) and the first optical element (8) in order to change at least one optical property of the tunable optical component (2).

14. Optical module (1) according to claim 13, wherein
The tunable optical component (2) and the first optical element (8) are displaceable along an optical axis (6) of the optical module (1) relative to each other, and wherein the actuator (11) is designed to cause a linear displacement between the tunable optical component (2) and the first optical element (8), in particular to change a focal power of the tunable optical component (2).

15. Optical module (1) according to claim 13, wherein
the tunable optical component (2) and the first optical element (8) are displaceable about at least one tilt axis that runs perpendicular to the optical axis (6) of the optical module (1), and wherein the actuator (11) is designed to cause a rotation between the tunable optical component (2) and the first optical element (8) about the tilt axis, in particular to cause an optical image stabilization with the optical module (1).
